(19) United States
(12) Patent Application Publication
(10) Pub. No.: US 2007/0275597 A1
(43) Pub. Date: Nov. 29, 2007

(54) Electrical connector and electrical connector assembly

(76) Inventor: Chih-Tsai Wang, Tainan City (TW)

Correspondence Address: SEYFARTH SHAW LLP, 131 S. DEARBORN ST., SUITE2400, CHICAGO, IL, 60603-5803, US

(21) Appl. No.: 11/656,313

(22) Filed: Jan. 19, 2007

(30) Foreign Application Priority Data
May 26, 2006 (TW) 095118786

(51) Int. Cl. H01R 13/40

(52) U.S. Cl. 439/587

(57) ABSTRACT

An electrical connector assembly includes two interconnected electrical connectors. Each of the electrical connectors includes a terminal seat, a terminal, and a retaining ring. The terminal seat is made of a plastic material, and has an inward flange extending radially and inwardly therefrom and defining an insert hole. The terminal includes a connecting section extending through the insert hole, and front and rear outward flanges extending radially and outwardly therefrom. The retaining ring is sleeved on the connecting section and disposed between the front and rear outward flanges. The inward flange of the terminal seat has front and rear side surfaces abutting respectively against an abutment surface of the retaining ring and the rear outward flange so as to prevent movement of the terminal within the terminal seat.

### CROSS-REFERENCE TO RELATED APPLICATION

This application claims priority of Taiwanese Application No. 095118786, filed on May 26, 2006.

### BACKGROUND OF THE INVENTION

1. Field of the Invention

This invention relates to a connector, and more particularly to an electrical connector and an electrical connector assembly that includes two interconnected electrical connectors.

2. Description of the Related Art

Various electrical connectors are used to interconnect electrical cables. However, most conventional electrical connectors are difficult to assemble and disassemble.

### SUMMARY OF THE INVENTION

The object of this invention is to provide an electrical connector that is easy to assemble and disassemble.

According to an aspect of this invention, there is provided an electrical connector comprising:

a terminal seat made of a plastic material and including a surrounding wall disposed around a central axis and having a rear end, and an inward flange extending radially and inwardly from the rear end of the surrounding wall toward the central axis and having opposite front and rear side surfaces and an inner periphery that defines an insert hole;

a terminal including a connecting section extending through the insert hole in the terminal seat, a front outward flange extending radially and outwardly from the terminal and disposed immediately in front of the connecting section, and a rear outward flange extending radially and outwardly from the terminal and disposed immediately behind the connecting section, the rear outward flange having a front side surface abutting against the rear side surface of the inward flange of the terminal seat; and

a retaining ring sleeved on the connecting section of the terminal and disposed between the front and rear outward flanges, the retaining ring being formed with an annular abutment surface abutting against the front side surface of the inward flange of the terminal seat so as to prevent movement of the terminal within the terminal seat.

An assembly process of the electrical connector includes the steps of:

sleeving the retaining ring on the connecting section between the front and rear outward flanges; and

inserting the terminal into the rear end of the terminal seat until the retaining ring is moved through the insert hole.

As such, the electrical connector is easy to assemble.

A disassembly process of the electrical connector includes the steps of:

inserting an ejecting tube to contact and push the retaining ring rearwardly to thereby eject an assembly of the terminal and the retaining ring from the terminal seat; and

removing the retaining ring from the terminal.

As such, the electrical connector is easy to disassemble.

According to another aspect of this invention, there is provided an electrical connector assembly comprising:

a female connector including
a first terminal seat including a surrounding wall, a first inward flange extending radially and inwardly from a rear end of the first surrounding wall, a resilient pushing plate extending integrally form and disposed pivotally on and above the surrounding wall, and a retaining hole formed through a front end portion of the pushing plate, the first inward flange defining a first insert hole and having front and rear side surfaces,
a first terminal including a first connecting section extending through the first insert hole, a first front outward flange extending radially and outwardly from the first terminal and disposed immediately in front of the first connecting section, a first rear outward flange extending radially and outwardly from the first terminal and disposed immediately behind the first connecting section, and a first contact end disposed in front of the first outward flange, the first rear outward flange having a front side surface abutting against the rear side surface of the first inward flange, and
a first retaining ring sleeved on the first connecting section and disposed between the first front outward flange and the first rear outward flange, the first retaining ring being formed with an annular abutment surface abutting against the front side surface of the first inward flange so as to prevent movement of the first terminal within the first terminal seat; and

a male connector disposed in front of the female connector and including
a second terminal seat including a second surrounding wall inserted into the first surrounding wall via a front end of the first surrounding wall, a second inward flange extending radially and inwardly from a front end of the second surrounding wall, and a protrusion extending upwardly from the second surrounding wall into the retaining hole in the pushing plate so as to prevent movement of the male connector within the female connector, the second inward flange defining a second insert hole and having front and rear side surfaces,
a second terminal including a second connecting section extending through the second insert hole, a second front outward flange extending radially and outwardly from the second terminal and disposed immediately in front of the second connecting section, a second rear outward flange extending radially and outwardly from the second terminal and disposed immediately behind the second connecting section, and a second contact end disposed behind the second outward flange and engaging electrically and removably the first contact end of the female connector, the second front outward flange having a rear side surface abutting against the front side surface of the second inward flange, and
a second retaining ring sleeved on the second connecting section and disposed between the second front outward flange and the second rear outward flange, the second retaining ring being formed with a second abutment surface abutting against the rear side surface of the second inward flange so as to prevent movement of the second terminal within the second terminal seat;

wherein the pushing plate is operable to remove the protrusion of the male connector from the retaining hole in the pushing plate.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is an exploded perspective view of the first preferred embodiment of an electrical connector according to this invention;

FIG. 2 is a schematic sectional view of the first preferred embodiment;

FIG. 3 is a view similar to FIG. 2, illustrating how an assembly of a terminal and a retaining ring is removed from a terminal seat by an ejecting tube;

FIG. 4 is a schematic sectional view of the second preferred embodiment of an electrical connector according to this invention;

FIG. 5 is a schematic sectional view of the third preferred embodiment of an electrical connector according to this invention;

FIG. 6 is a schematic sectional view of the fourth preferred embodiment of an electrical connector according to this invention;

FIG. 7 is an exploded view of the fifth preferred embodiment of an electrical connector according to this invention;

FIG. 8 is a schematic sectional view of the fifth preferred embodiment;

FIG. 9 is a schematic exploded sectional view of an electrical connector assembly according to this invention; and

FIG. 10 is a schematic assembled sectional view of the electrical connector assembly.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

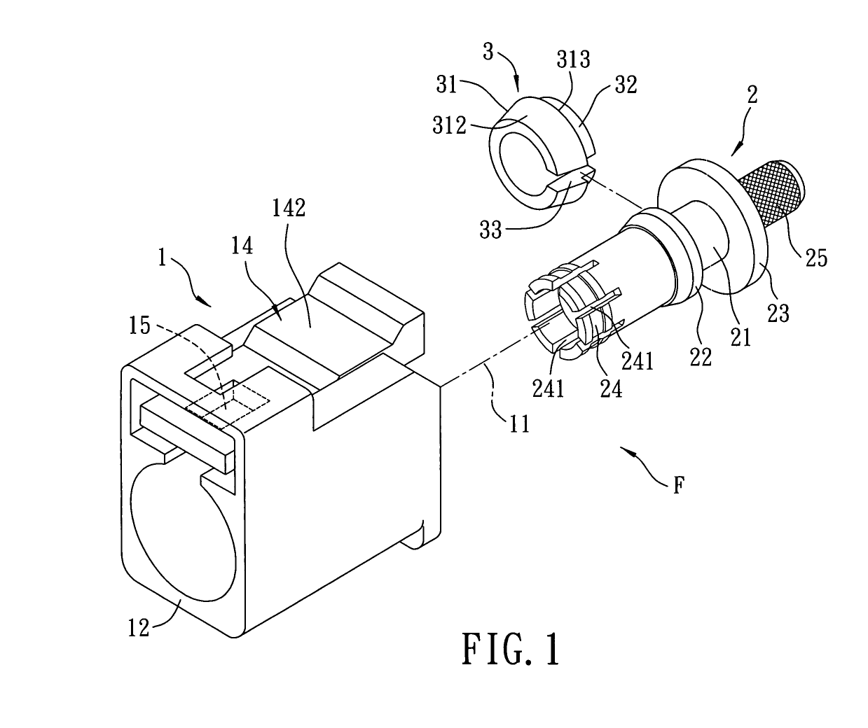

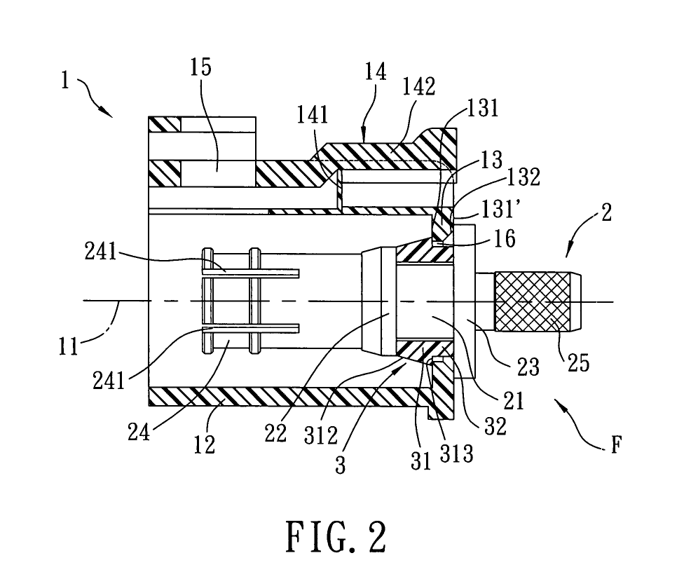

Referring to FIGS. 1 and 2, the first preferred embodiment of an electrical connector (F) according to this invention includes a terminal seat 1, a terminal 2, and a retaining ring 3.

The terminal seat 1 is made of a plastic material, and includes a surrounding wall 12 disposed around a central axis 11, an inward flange 13 extending radially and inwardly from a rear end of the surrounding wall 12 toward the central axis 11, a resilient pushing plate 14 extending integrally from and disposed pivotally on and above the surrounding wall 12, and a retaining hole 15 formed through a front end portion of the pushing plate 14. An inner periphery of the inward flange 13 defines an insert hole 16. The inward flange 13 has vertical front and rear side surfaces 131, 131′, and a frusto-conical guiding surface 132 extending forwardly and inwardly from an inner periphery of the rear side surface 131′ toward the central axis 11. The pushing plate 14 has a fulcrum post 141 extending upwardly from a middle portion of the surrounding wall 12, and a swingable plate portion 142 having a middle portion formed integrally with a top end of the fulcrum post 141. The retaining hole 15 is formed in the swingable plate portion 142.

The terminal 2 is made of metal, and includes a connecting section 21 extending through the insert hole 16 and having a uniform outer diameter, a front outward flange 22 extending radially and outwardly from the terminal 2 and disposed immediately in front of the connecting section 21, a rear outward flange 23 extending radially and outwardly from the terminal 2 and disposed immediately behind the connecting section 21, a contact end 24 disposed in front of the front outward flange 22 and having a plurality of open-ended axial slots 241, and a cable-coupling end 25 disposed behind the rear outward flange 23 and coupled electrically to an electrical cable (not shown) or a signal transmission cable (not shown). The rear outward flange 23 has a front side surface abutting against the rear side surface 131′ of the inward flange 13.

The retaining ring 3 is made of a plastic material, and is configured as a C-shaped retainer ring having two ends defining a notch 33 therebetween. The retaining ring 3 has a uniform inner diameter, a generally frusto-conical front ring portion 31, and a generally circular tubular rear ring portion 32 formed integrally with and disposed behind the front ring portion 31. A rear end of the front ring portion 31 has an outer diameter greater than that of a front end of the rear ring portion 32 so as to define therebetween a shoulder constituting an annular abutment surface 313. The front ring portion 31 is formed with a frusto-conical outer surface 312 having an outer diameter that increases rearwardly and gradually so as to guide movement of the retaining ring 3 into the insert hole 16 in the terminal seat 1. The retaining ring 3 is sleeved on the connecting section 21 of the terminal 2, and is disposed between the front and rear outward flanges 22, 23. As such, movement of the terminal 2 within the terminal seat 1 is prevented.

The assembly process of the electrical connector (F) includes the following steps: sleeving the retaining ring 3 on the connecting section 21 between the front and rear outward flanges 22, 23; and inserting an assembly of the terminal 2 and the retaining ring 3 into the insert hole 16 until the rear outward flange 23 of the terminal 2 abuts against the rear side surface 131′ of the inward flange 13. Since the retaining ring 3 is C-shaped, when the retaining ring 3 moves within the insert hole 16, the ends of the retaining ring 3 move toward each other such that the notch 33 gets smaller. As such, the electrical connector (F) is easy to assemble.

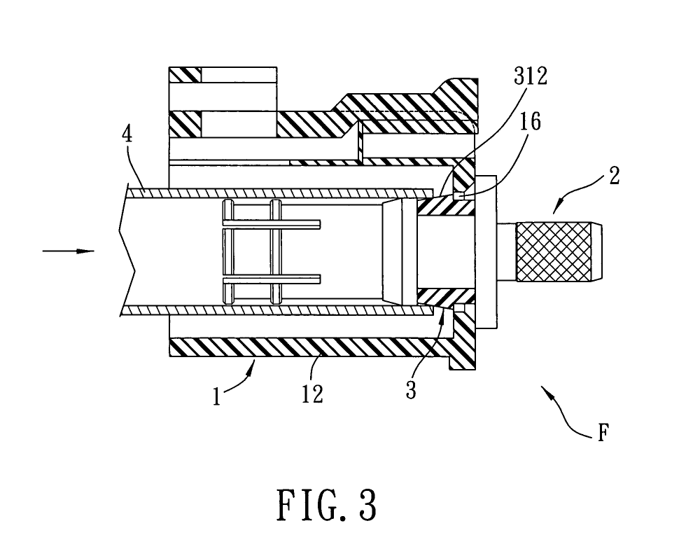

Preferably, referring to FIG. 3, the electrical connector (F) further includes an ejecting tube 4. The ejecting tube 4 is disposed within the surrounding wall 12 of the terminal seat 1, and has an open rear end in contact with an intermediate portion of the frusto-conical outer surface 312 of the retaining ring 3. The ejecting tube 4 is movable within the terminal seat 1 so as to push rearwardly and eject an assembly of the terminal 2 and the retaining ring 3 from the terminal seat 1. Subsequently, the retaining ring 3 can be removed from the terminal 2. As such, the electrical connector (F) is easy to disassemble.

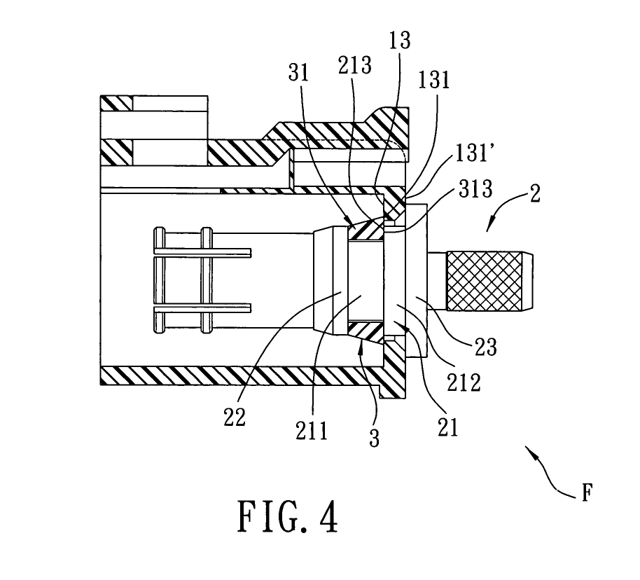

FIG. 4 shows the second preferred embodiment of an electrical connector (F) according to this invention, which is similar in construction to the first preferred embodiment. In contrast to the first preferred embodiment, the rear ring portion 32 (see FIG. 1) is omitted, and the connecting section 21 has a small-diameter front portion 211 and a large-diameter rear portion 212 that is connected to and disposed behind the front portion 211 and that has an outer diameter greater than that of the front portion 211. A shoulder 213 is defined between the front and rear portions 211, 212. A rear end surface of the retaining ring 3 constitutes the abutment surface 313, and abuts against both the front side surface 131 of the inward flange 13 and the shoulder 213.

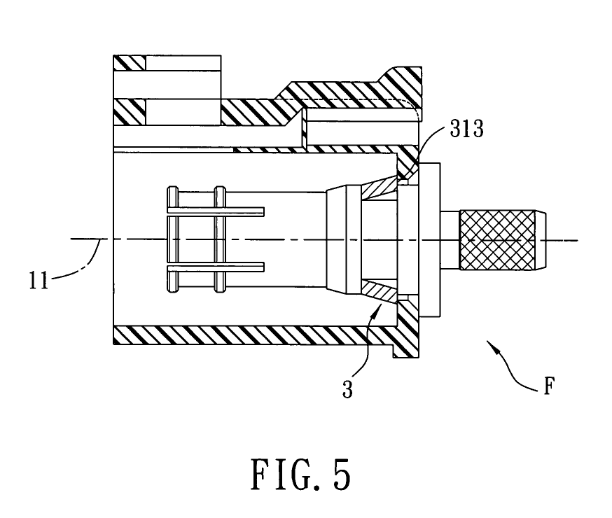

FIG. 5 shows the third preferred embodiment of an electrical connector (F) according to this invention, which is similar in construction to the second preferred embodiment except that the retaining ring 3 is made of metal, and has inner and outer diameters, each of which increases rearwardly and gradually. The retaining ring 3 further has a rear end surface constituting the abutment surface 313.

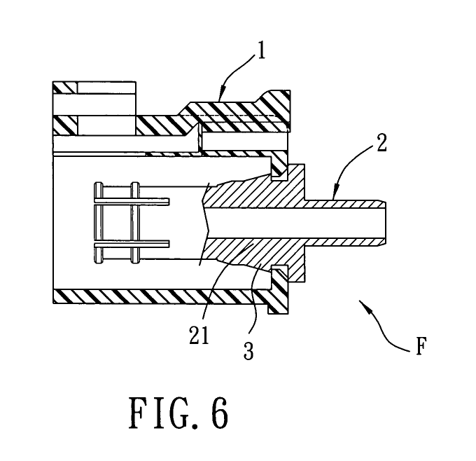

FIG. 6 shows the fourth preferred embodiment of an electrical connector (F) according to this invention, which is similar in construction to the first and second preferred embodiments except that the retaining ring 3 is formed integrally with the connecting section 21, and is made of metal.

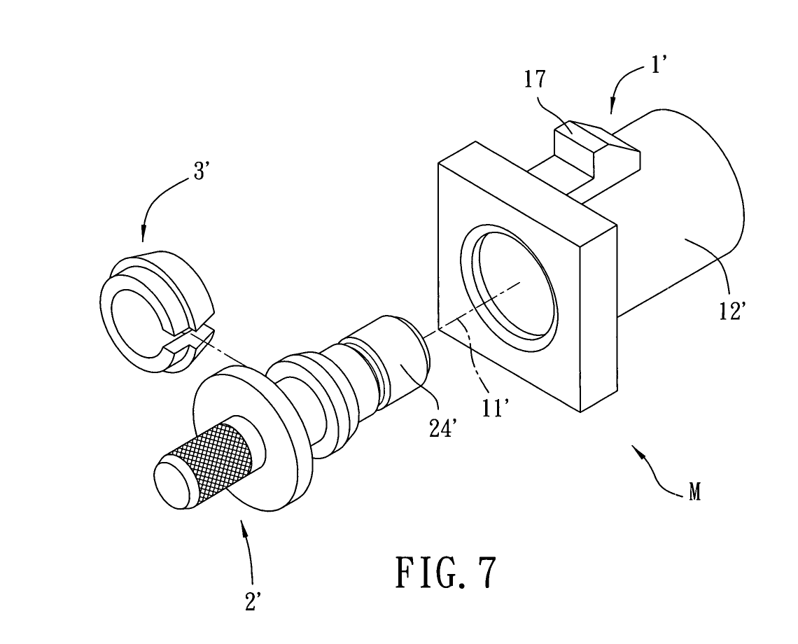

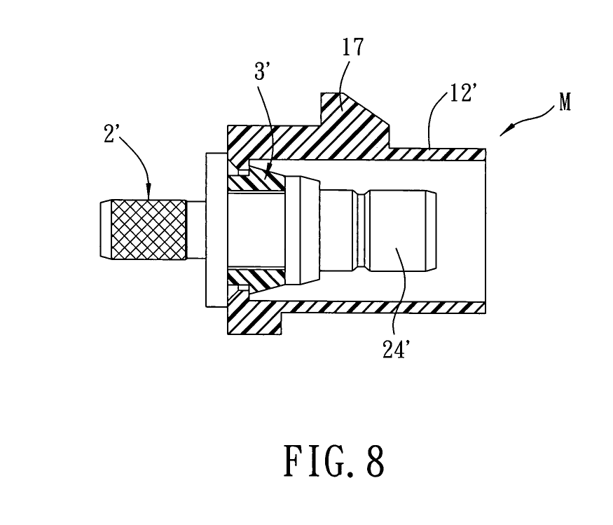

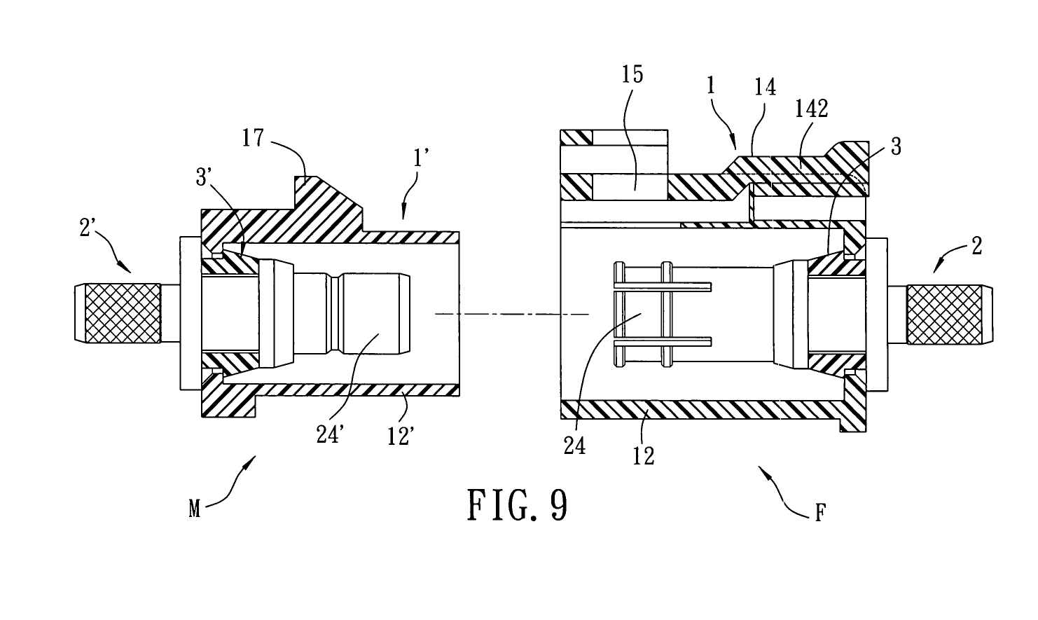

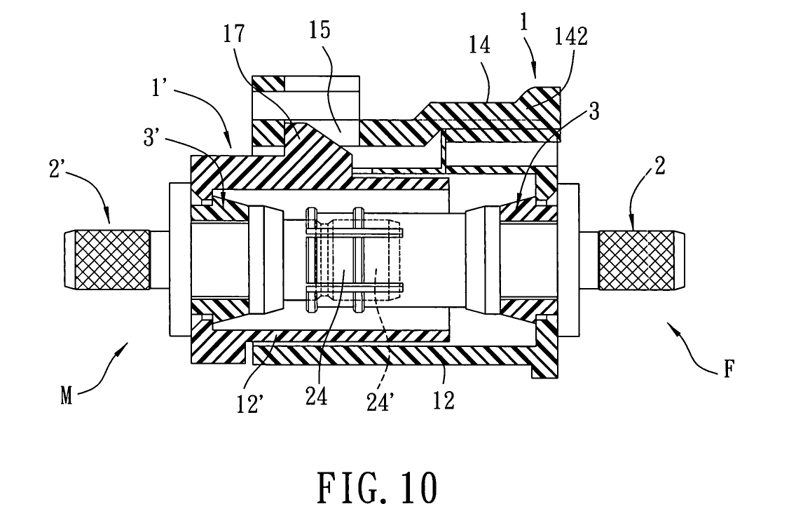

FIGS. 7 and 8 show the fifth preferred embodiment of an electrical connector (M) according to this invention, which is similar in construction to the first preferred embodiment and which can be coupled electrically to any of the first, second, third, and fourth preferred embodiments. In contrast to the first preferred embodiment, the electrical connector (M) of this embodiment is inverted along the central axis 11′. That is, the terminal 2′ and the retaining ring 3′ are disposed in front of the terminal seat 1′. In addition, the pushing plate 14 (see FIG. 1) is replaced with a protrusion 17 extending upwardly from the surrounding wall 12′, and the contact end 24′ of the terminal 2′ has an outer diameter slightly smaller than that of the first, second, third, and fourth preferred embodiments, and is not formed with the axial slots 241 (see FIG. 1). As such, referring to FIGS. 9 and 10, the surrounding wall 12′ of the electrical connector (M) (referred to as the male connector hereinafter) of the fifth preferred embodiment may be inserted into the surrounding wall 12 of a selected one (referred to as the female connector hereinafter) of the electrical connectors (F) of the first, second, third, and fourth preferred embodiments via a front end of the female connector (F). Hence, the protrusion 17 of the male connector (M) engages the retaining hole 15 in the female connector (F), and the contact end 24′ of the male connector (M) is coupled electrically to the contact end 24 of the female connector (F). Thus, the male and female connectors (M, F) constitute cooperatively a connector assembly.

A rear end of the pushing plate 14 may be depressed downwardly so as to remove the protrusion 17 from the corresponding retaining hole 15, thereby allowing for separation of the male and female connectors (M, F).

With this invention thus explained, it is apparent that numerous modifications and variations can be made without departing from the scope and spirit of this invention. It is therefore intended that this invention be limited only as indicated by the appended claims.

I claim:

1. An electrical connector comprising:
a terminal seat made of a plastic material and including a surrounding wall disposed around a central axis and having a rear end, and an inward flange extending radially and inwardly from said rear end of said surrounding wall toward said central axis and having opposite front and rear side surfaces, and an inner periphery that defines an insert hole;
a terminal including a connecting section extending through said insert hole in said terminal seat, a front outward flange extending radially and outwardly from said terminal and disposed immediately in front of said connecting section, and a rear outward flange extending radially and outwardly from said terminal and disposed immediately behind said connecting section, said rear outward flange having a front side surface abutting against said rear side surface of said inward flange of said terminal seat; and
a retaining ring sleeved on said connecting section of said terminal and disposed between said front and rear outward flanges, said retaining ring being formed with an annular abutment surface abutting against said front side surface of said inward flange of said terminal seat so as to prevent movement of said terminal within said terminal seat.

2. The electrical connector as claimed in claim 1, wherein said inward flange of said terminal seat is formed with a frusto-conical guiding surface that extends forwardly and inwardly from an inner periphery of said rear side surface of said inward flange toward said central axis;
whereby, during assembly, said retaining ring is guided into said insert hole in said terminal seat by said frusto-conical guiding surface of said terminal seat.

3. The electrical connector as claimed in claim 2, wherein said retaining ring is formed with a frusto-conical outer surface having an outer diameter that increases rearwardly and gradually so as to guide movement of said retaining ring into said insert hole in said terminal seat.

4. The electrical connector as claimed in claim 1, wherein said retaining ring is formed with a frusto-conical outer surface having a diameter that increases rearwardly and gradually so as to guide movement of said retaining ring into said insert hole in said terminal seat.

5. The electrical connector as claimed in claim 4, wherein said retaining ring is configured as a C-shaped retaining ring that has two ends defining a notch therebetween, said ends of said retaining ring moving toward each other such that said notch gets smaller when said retaining ring moves within said insert hole in said terminal seat.

6. The electrical connector as claimed in claim 5, wherein said retaining ring is made of a plastic material.

7. The electrical connector as claimed in claim 6, wherein said connecting section of said terminal has a uniform outer diameter, said retaining ring having a uniform inner diameter, a generally frusto-conical front ring portion, and a generally circular tubular rear ring portion formed integrally with and disposed behind said front ring portion, a rear end of said front ring portion having an outer diameter greater than that of a front end of said rear ring portion so as to define therebetween a shoulder constituting said abutment surface.

8. The electrical connector as claimed in claim 6, wherein said retaining ring has a uniform inner diameter, an outer diameter increasing rearwardly and gradually, and a rear end surface constituting said abutment surface, said connecting section having a small-diameter front portion and a large-diameter rear portion that is connected to and disposed behind said front portion and that has an outer diameter greater than that of said front portion so as to define a shoulder between said front and rear portions, said retaining ring being sleeved on said front portion of said connecting section such that said shoulder abuts against said rear end surface of said retaining ring.

9. The electrical connector as claimed in claim 5, wherein said retaining ring is made of metal.

10. The electrical connector as claimed in claim 9, wherein said retaining ring has inner and outer diameters, each of which increases rearwardly and gradually, said retaining ring further having a rear end surface constituting said abutment surface.

11. The electrical connector as claimed in claim 5, further comprising an ejecting tube disposed within said surrounding wall of said terminal seat and having an open rear end in contact with an intermediate portion of said frusto-conical outer surface of said retaining ring, said ejecting tube being movable within said terminal seat so as to push rearwardly and eject an assembly of said terminal and said retaining ring from said terminal seat.

12. The electrical connector as claimed in claim 4, wherein said retaining ring is formed integrally with said connecting section of said terminal, and is made of metal.

13. An electrical connector assembly comprising:
a female connector including
a first terminal seat including a first surrounding wall, a first inward flange extending radially and inwardly from a rear end of said first surrounding wall, a resilient pushing plate extending integrally from and disposed pivotally on and above said first surrounding wall, and a retaining hole formed through a front end portion of said pushing plate, said first inward flange defining a first insert hole and having front and rear side surfaces,
a first terminal including a first connecting section extending through said first insert hole, a first front outward flange extending radially and outwardly from said first terminal and disposed immediately in front of said first connecting section, a first rear outward flange extending radially and outwardly from said first terminal and disposed immediately behind said first connecting section, and a first contact end disposed in front of said first outward flange, said first rear outward flange having a front side surface abutting against said rear side surface of said first inward flange, and
a first retaining ring sleeved on said first connecting section and disposed between said first front outward flange and said first rear outward flange, said first retaining ring being formed with an annular abutment surface abutting against said front side surface of said first inward flange so as to prevent movement of said first terminal within said first terminal seat; and
a male connector disposed in front of said female connector and including
a second terminal seat including a second surrounding wall inserted into said first surrounding wall via a front end of said first surrounding wall, a second inward flange extending radially and inwardly from a front end of said second surrounding wall, and a protrusion extending upwardly from said second surrounding wall into said retaining hole in said pushing plate so as to prevent movement of said male connector within said female connector, said second inward flange defining a second insert hole and having front and rear side surfaces,
a second terminal including a second connecting section extending through said second insert hole, a second front outward flange extending radially and outwardly from said second terminal and disposed immediately in front of said second connecting section, a second rear outward flange extending radially and outwardly from said second terminal and disposed immediately behind said second connecting section, and a second contact end disposed behind said second outward flange and engaging electrically and removably said first contact end of said female connector, said second front outward flange having a rear side surface abutting against said front side surface of said second inward flange, and
a second retaining ring sleeved on said second connecting section and disposed between said second front outward flange and said second rear outward flange, said second retaining ring being formed with a second abutment surface abutting against said rear side surface of said second inward flange so as to prevent movement of said second terminal within said second terminal seat;
wherein said pushing plate is operable to remove said protrusion of said male connector from said retaining hole in said pushing plate.

14. The connector assembly as claimed in claim 13, wherein said pushing plate has a fulcrum post extending upwardly from a middle portion of said first surrounding wall, and a swingable plate portion having a middle portion formed integrally with a top end of said fulcrum post, said retaining hole being formed in said swingable plate portion.
